(19) United States
(12) Patent Application Publication
(10) Pub. No.: US 2005/0041194 A1
(43) Pub. Date: Feb. 24, 2005

(54) Liquid crystal display having narrow cell gap and method of producing the same

(75) Inventors: Seok-Lyul Lee, Taoyuan Hsien (TW); Shao-Wu Hsu, Chia Yi City (TW); Ming-Tien Lin, Lu Chou City (TW)

Correspondence Address: Richard I. Byrne, 700 Koppers Building, 436 Seventh Avenue, Pittsburgh, PA, 15219-1818, US

(73) Assignee: HANNSTAR DISPLAY CORPORATION

(21) Appl. No.: 10/883,274

(22) Filed: Jul. 1, 2004

(30) Foreign Application Priority Data
Aug. 19, 2003 (TW) 92122784

(51) Int. Cl. G02F 1/1339

(52) U.S. Cl. 349/155

(57) ABSTRACT

A liquid crystal display (LCD) having a narrow cell gap is produced by a one-drop fill (ODF) process. Openings are formed in the protection layer on a thin film transistor (TFT) array substrate. These openings are located on the corresponding positions of photoresist spacers and a photoresist guard ring on a color filter substrate to receive the photoresist spacers and the photoresist guard ring and allow them to be in contact with the TFT array substrate. Therefore, the poor display quality problem caused by the photoresist spacers and the photoresist guard ring with uneven heights can be resolved.

### BACKGROUND OF THE INVENTION

1. Field of Invention

The present invention relates to a liquid crystal display and a method of producing the same. More particularly, the present invention relates to a liquid crystal display having a narrow cell gap and a method of producing the same.

2. Description of Related Art

With the progress of the technology development, liquid crystal display (LCD) has been widely applied in many display devices of various electronic products, such as projection televisions, mobile phones, and cameras. Therefore, higher quality LCDs are required, and LCD processes must accordingly be improved.

A one-drop fill (ODF) process has replaced the conventional liquid crystal injection process to simplify the LCD processes. Control of cell gap uniformity of an LCD is very important for the ODF process. If the cell gap uniformity is poor, a color mura phenomena will occur when the LCD displays images. Furthermore, the cell gap also needs to be decreased to increase the electrical field strength. Thus, the response time of liquid crystal molecules is decreased to increase the LCD display quality. Therefore, one development trend in LCD production is a narrower cell gap.

However, producing an LCD having a uniform narrow cell gap is difficult. FIG. 1 is a cross-sectional diagram of a conventional LCD having a narrow cell gap. In FIG. 1, a right part of the dashed line 105 is active area 140 with LCD pixels located therein. A left part of the dashed line 105 is peripheral area 150 where control circuits and other peripheral circuits are located.

In FIG. 1, a protection layer 125 is located on a first substrate 110, and photoresist spacers 135a and a photoresist guard ring 135b are formed on a second substrate 120. The photoresist guard ring 135b is located along the margin of the second substrate 120 to surround the liquid crystal layer 132 formed by a subsequent ODF process. Then, the first substrate 110 and the second substrate 120 are assembled so that they are parallel to each other, and the protection layer 125, the photoresist spacers 135a and the photoresist guard ring 135b are located between the first substrate 110 and the second substrate 120. A sealant 130 is used to seal the space between the first substrate 110 and the second substrate 120. Hence, the distance between the surface of the second substrate 120 and the surface of the protection layer 125 is the cell gap 138.

The heights of the photoresist spacers 135a and the photoresist guard ring 135b have to be the same as that of the cell gap 138 to maintain the cell gap 138. Due the limited precision of the process, some deviations occur between the heights of the photoresist spacers 135a and the photoresist guard ring 135b and that of the cell gap 138. In addition, the compressibility of the photoresist spacers 135a and the photoresist guard ring 135b is less when the cell gap 138 is narrower. Therefore, when the photoresist spacers 135a and the photoresist guard ring 135b are shorter than 3 μm, the compressible amount is usually less than the height deviations. Thus, a uniform cell gap 138 throughout the entire LCD is difficult to achieve.

For example, when the desired heights of the photoresist spacers 135a and the photoresist guard ring 135b are 2.5 μm, the height deviations of the individual photoresist spacers 135a and the photoresist guard ring 135b are about ±0.4 μm. However, the compressible amount of these photoresist spacers 135a and the photoresist guard ring 135b is only about 0.1-0.2 μm. Therefore, after the assembling process in a vacuum, the heights of these photoresist spacers 135a and the photoresist guard ring 135b is about 2.2-2.7 μm, and some photoresist spacers 135a and the photoresist guard ring 135b thus cannot be closely in contact with the protection layer 125 on the first substrate 110.

If the photoresist spacers 135a are not closely in contact with the protection layer 125 to leave a pore 148, a color mura problem occurs when the LCD panel displays images. If the photoresist guard ring 135b is not closely in contact with the protection layer 125 to leave a pore 158, the sealant 130, before curing, will contaminate the liquid crystal layer 132 through pore 158 and Chrominance is not uniform when the LCD displays images.

### SUMMARY OF THE INVENTION

In one aspect, the present invention provides an LCD having a narrow cell gap and method of producing the same so that the heights of the photoresist spacers and photoresist guard ring are uniform after assembling the two substrates of an LCD.

In another aspect, the present invention provides an LCD having a narrow cell gap and method producing the same to solve the problem of liquid crystal contamination and thus increase the LCD yield.

In accordance with the foregoing and other aspects of the present invention, an LCD having a narrow cell gap is provided. The LCD comprises a first substrate, a second substrate, a protection layer, photoresist spacers, a photoresist guard ring, a liquid crystal layer and sealant. The second substrate is parallel with the first substrate. The protection layer is on a surface, facing the second substrate, of the first substrate and has openings to expose the surface of the first substrate. The photoresist spacers are located between the first and second substrate and respectively within the openings of the protection layer to be in contact with both the first and second substrate. The photoresist guard ring is located between the first and second substrate to be in contact with both the first and second substrate and surrounding an edge of the protection layer. The liquid crystal layer is located in a space enclosed by the first and second substrate and the photoresist guard ring. The sealant surrounds the photoresist guard ring to seal the first and second substrate.

In accordance with the foregoing and other aspects of the present invention, a method producing an LCD having a narrow cell gap is provided. A protection layer is formed on a first substrate and then is patterned to form openings in the protection layer to expose a surface of the first substrate. A photoresist layer is formed on a second substrate and is then patterned to form photoresist spacers on corresponding sites of the openings and a photoresist guard ring on a corresponding position surrounding the protection layer. A sealant is coated on a rim of the first substrate, and a liquid crystal material is dropped on a center of the first substrate. The first and second substrate are assembled parallel to each other and sealed by the sealant so that the photoresist spacers extend into the openings and are in contact with the first substrate; the photoresist guard ring surrounds the protection layer. The sealant is then cured to finish the LCD production.

According to another embodiment of the present invention, a margin opening can be also formed in the margin of the protection layer to accommodate the photoresist guard ring.

In the foregoing, the first substrate and second substrate of the LCD can be a thin film transistor array plate and a color filter plate or a color filter on array plate and an ITO glass plate/a glass plate, respectively. The sealant can be a thermosetting sealant or a UV-curable sealant.

In conclusion, a photoresist layer thicker than required cell gap is used to form the photoresist spacers and the photoresist guard ring in the preferred embodiment of the invention. Hence, under the same pressure, the photoresist spacers and the photoresist guard ring can have a better compressibility. The heights of the photoresist spacers and the photoresist guard ring can then be more uniform and be in contact with the first substrate. Therefore, an LCD having a narrow cell gap can be obtained and the problems of the color mura and the liquid crystal contaminated by the sealant can also be resolved.

It is to be understood that both the foregoing general description and the following detailed description are made by use of examples and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional diagram of a conventional LCD having a narrow cell gap;

FIG. 2 is a cross-sectional diagram of an LCD having a narrow cell gap according to a preferred embodiment of the present invention; and

FIG. 3 is a cross-sectional diagram of an LCD having a narrow cell gap according to another preferred embodiment of the present invention.

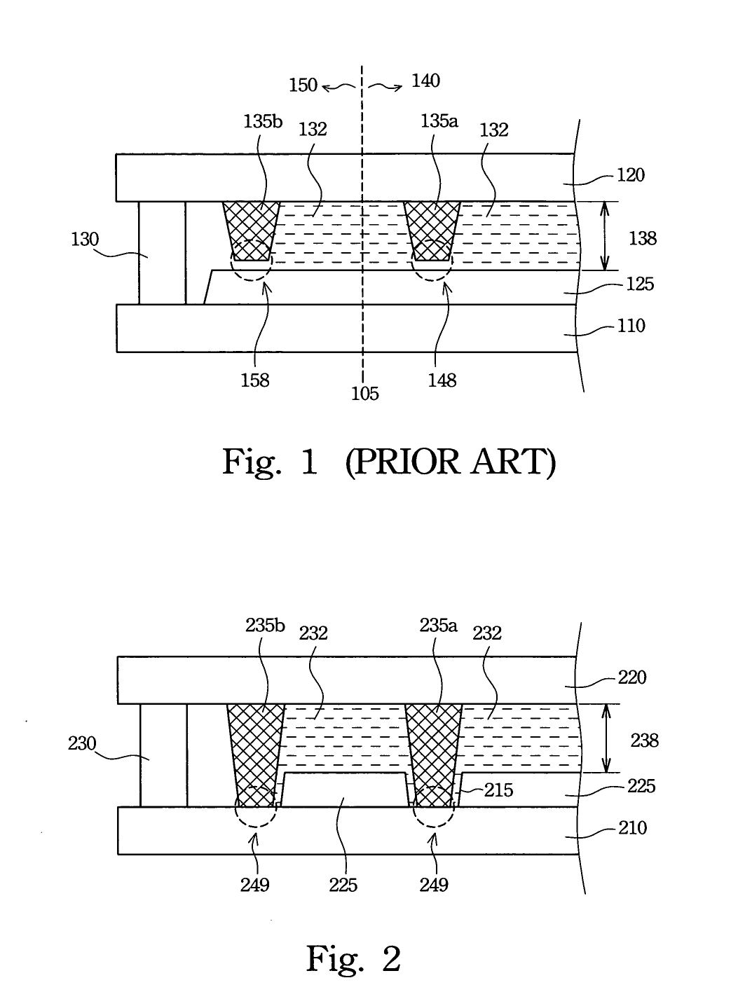

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a cross-sectional diagram of an LCD having a narrow cell gap according to a preferred embodiment of the present invention. In FIG. 2, a protection layer 225 is formed on a first substrate 210, and then several openings 215 are formed in the protection layer 225 to expose the surface of the first substrate 210. A photoresist layer is formed either on a second substrate 220 or on the first substrate 210, and then photolithography is performed to form photoresist spacers 235a on corresponding sites of the openings 215 and photoresist guard ring 235b surrounding the protection layer 225.

Sealant 230 is coated either on the first substrate 210 or on the second substrate 220. Next, a one-drop fill (ODF) process is performed to drop liquid crystal 232 on center of the first substrate 210 or the second substrate 220. The first substrate 210 and the second substrate 220 are aligned to locate the photoresist spacers 235a respectively in the openings 215 and the photoresist guard ring 235b surrounding the protection layer 225 to be in contact with the other substrate. Then the first substrate 210 and the second substrate 220 are assembled in a vacuum and sealed by the sealant 230. Finally, a heat or a UV treatment is performed to cure the sealant 230 completely.

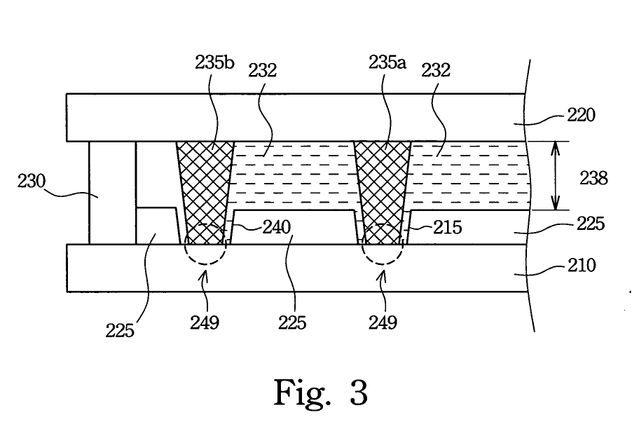

FIG. 3 is a cross-sectional diagram of an LCD having a narrow cell gap according to another preferred embodiment of the present invention. In FIG. 3, the producing processes are similar to those in FIG. 2 and further description thereof thus is omitted here. One of the differences between FIG. 2 and FIG. 3 is that a margin opening 240 is formed in the protection layer 225 at the same time as the openings 215 are formed. Another is that the photoresist guard ring 235b is located in the margin opening 240 but not at the edge of the protection layer.

In the forgoing, the first substrate 210 is a control-circuit plate, such as a thin film transistor plate, and the second substrate 220 is a color filter plate. The first substrate 210 also can be a color filter on array (COA) plate, and the second substrate 220 can be an ITO glass pate or a glass plate. If the display mode of the LCD is TN mode, the second substrate is an ITO plate. If the display mode of the LCD is IPS mode, the second substrate is a glass plate. The protection layer 25 is made by resin, silicon nitride or silicon oxide. The sealant 230 is made of a thermosetting sealant, a UV-curable sealant or a combination thereof, such as 50 wt % thermosetting sealant and 50 wt % UV-curable sealant.

The distance between the surface of the protection layer 225 and the surface of the second substrate 220 is gap 238. The gap 238 is about 1.0-4.0 μm, and preferably 2.5-3.0 μm. The thickness of the protection layer 225 is about 1.0-4.0 μm, and preferably 2.0-3.0 μm. Therefore, the height of the photoresist spacers 235a and the photoresist guard ring 235b is preferably 5.0-6.0 μm.

Compared with the conventional photoresist spacers and the photoresist guard ring having a height of only about 2.5-3.0 μm, the height of the photoresist spacers 235a and the photoresist guard ring 235b is about 5.0-6.0 μm according the preferred embodiment of the present invention. Therefore, the photoresist spacers 235a and the photoresist guard ring 235b can have a better compressibility under a certain pressure. For example, the compressibility of 5.0 μm high photoresist spacers and photoresist guard ring is about twice that of the 3.0 μm high photoresist spacers and photoresist guard ring under a pressure of about 15 gw per unit area.

The preferred embodiment of the present invention utilizes openings in the protection layer 225 to accommodate photoresist spacers 235a and the space surrounding the protection layer or the margin opening 240 in the protection layer 225 to accommodate the photoresist guard ring 235b. Hence, higher photoresist spacers and photoresist guard ring can be used to maintain the cell gap 238 of an LCD and have higher compressibility, while more uniform heights of the photoresist spacers 235a and the photoresist guard ring 235b can be obtained after assembling the first and second substrates 210 and 220. In addition, all of the photoresist spacers 235a and the photoresist guard ring 235b can be in contact with both the first and second substrates 210 and 220, as illustrated by area 249. Consequently, the problems of the color mura and the liquid crystal contaminated by the sealant can be resolved.

Higher photoresist spacers and photoresist guard ring are used in the LCD having narrow cell gap, as provided by the preferred embodiment of the present invention, to obtain more uniform heights of the photoresist spacers and photoresist guard ring after assembling the two substrates. Hence, a uniform cell gap of the LCD can be obtained to solve the color mura problem. In addition, the liquid crystal contamination problem can also be solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A LCD panel, comprising:
a first substrate;
a second substrate being parallel with the first substrate;
a protection layer on a surface, facing the second substrate, of the first substrate, the protection layer having openings to expose the surface of the first substrate;
photoresist spacers located between the first and second substrate and respectively within the openings of the protection layer to be in contact with both the first and second substrate;
a photoresist guard ring located between the first and second substrate to be in contact with both the first and second substrate and surrounding an edge of the protection layer;
a liquid crystal layer located in a space enclosed by the first and second substrate and the photoresist guard ring; and
a sealant surrounding the photoresist guard ring to seal the first and second substrate.

2. The LCD panel of claim 1, further comprising a margin opening near an edge of the protection layer to expose the surface of the first substrate, and the photoresist guard ring located between the first and second substrate and within the margin opening to be in contact with both the first and second substrate.

3. The LCD panel of claim 1, wherein the first substrate comprises a thin film transistor array plate, and the second substrate comprises a color filter plate.

4. The LCD panel of claim 1, wherein the first substrate comprises a color filter on array plate, and the second substrate comprises an ITO glass plate or a glass plate.

5. The LCD panel of claim 1, wherein a thickness of the protection layer is about 2.0-3.0 μm.

6. The LCD of claim 1, wherein a material of the protection layer comprises resin, silicon nitride or silicon oxide.

7. The LCD of claim 1, wherein a height of the photoresist spacers and the photoresist guard ring is about 5.0-6.0 μm.

8. The LCD of claim 1, wherein the sealant comprises a thermosetting sealant, a UV-curable sealant or a combination thereof.

9. A method of producing an LCD having a narrow cell gap, comprising:
forming a protection layer on a first substrate;
forming openings in the protection layer to expose a surface of the first substrate;
forming photoresist spacers on corresponding sites of the openings on a second substrate and a photoresist guard ring on corresponding position surrounding the protection layer on the second substrate;
coating a sealant on a rim of the first substrate;
dropping a liquid crystal material on a center of the first substrate;
parallel assembling the first and second substrate and sealing them with the sealant, wherein the photoresist spacers extend into the openings to be in contact with the first substrate and the photoresist guard ring surrounds the protection layer; and
curing the sealant.

10. The method of claim 9, wherein the step of forming openings in the protection layer further comprises forming a margin opening near an edge of the protection layer to expose the surface of the first substrate, and the photoresist guard ring is formed on a corresponding site of the margin opening, in the step of forming the photoresist spacers and the photoresist guard ring, to extend into the margin opening to be in contact with the first substrate in the parallel assembling step.

11. The method of claim 9, wherein the first substrate comprises a thin film transistor array plate, and the second substrate comprises a color filter plate.

12. The method of claim 9, wherein the first substrate comprises a color filter on array plate, and the second substrate comprises an ITO glass plate or a glass plate.

13. The method of claim 9, wherein a thickness of the protection layer is about 2.0-3.0 μm.

14. The method of claim 9, wherein a material of the protection layer comprises resin, silicon nitride or silicon oxide.

15. The method of claim 9, wherein a height of the photoresist spacers and the photoresist guard ring is about 5.0-6.0 μm.

16. The method of claim 9, wherein the sealant comprises a thermosetting sealant, a UV-curable sealant or a combination thereof.

17. The method of claim 9, wherein the first substrate is replaced by the second substrate in the step of coating the sealant.

18. The method of claim 9, wherein the first substrate is replaced by the second substrate in the step of dropping the liquid crystal.

19. The method of claim 9, wherein the second substrate is replaced by the first substrate in the steps of forming and patterning the photoresist layer.
